(19) United States
(12) Patent Application Publication
(10) Pub. No.: US 2026/0147474 A1
(43) Pub. Date: May 28, 2026

(54) IN-VEHICLE INFORMATION TERMINAL APPARATUS AND CONTROL METHOD

(71) Applicant: Honda Motor Co., Ltd., Tokyo (JP)

(72) Inventors: Takaaki Sato, Tokyo (JP); Yoshihito Bando, Tokyo (JP); Kensuke Kanamori, Tokyo (JP); Junya Ishizaki, Tokyo (JP)

(21) Appl. No.: 19/397,531

(22) Filed: Nov. 21, 2025

(30) Foreign Application Priority Data
Nov. 28, 2024 (JP) 2024-207687

(51) Int. Cl. G06F 3/04886; G06F 3/041

(52) U.S. Cl. CPC G06F 3/04886; G06F 3/04166; G06F 2203/04104; G06F 2203/04803

(57) ABSTRACT

An in-vehicle information terminal apparatus including a touch panel input portion, a display unit and a microprocessor. The microprocessor is configured to perform controlling the display unit to display information in a first and second display areas arranged side by side in a left-right direction on the display unit, the first and second display areas being two information display areas each having a tile-like shape, storing first input trajectory information including information of the input trajectory on the first display area detected by the touch panel input portion and second input trajectory information including information of the input trajectory on the second display area detected by the touch panel input portion, in the memory, and determining a number of operators or identifying the operator, based on the first input trajectory information and the second input trajectory information stored in the memory.

### CROSS-REFERENCE TO RELATED APPLICATION

This application is based upon and claims the benefit of priority from Japanese Patent Application No. 2024-207687 filed on Nov. 28, 2024, the content of which is incorporated herein by reference.

### BACKGROUND OF THE INVENTION

### Field of the Invention

This invention relates to an in-vehicle information terminal apparatus including a touch panel input portion, and a control method.

### Description of the Related Art

There has been known technology for in-vehicle information terminal devices, such as IVI (In-Vehicle Infotainment) systems and in-vehicle navigation systems, which take into consideration operation not only by the driver but also by the front passenger. For example, Japanese Unexamined Patent Publication No. JP2020-041826 (JP 2020-041826 A) describes a device that permits operation of a navigation device even while the vehicle is traveling, when an object detector installed on the passenger side determines that the navigation device is being operated by the passenger.

However, providing a detection unit to detect the passenger's hand on the passenger side, as in the device described in JP 2020-041826 A, in order to determine whether the operator is the driver or the front passenger, increases cost.

### SUMMARY OF THE INVENTION

An aspect of the present invention is an in-vehicle information terminal apparatus including a touch panel input portion including a touch sensor configured to detect an input trajectory of a flick operation performed by an operator, a display unit, and an electronic control unit having a microprocessor and a memory connected to the microprocessor. The input trajectory is defined as a movement trajectory of a finger from a flick operation start point, where the operator touches a surface of the touch panel input portion, to a flick operation end point, where the operator releases the finger after moving the finger along the surface while maintaining contact. The microprocessor is configured to perform controlling the display unit to display information in a first display area and a second display area arranged side by side in a left-right direction on the display unit, the first display area and the second display area being two information display areas each having a tile-like shape, storing, in the memory, first input trajectory information including information of the input trajectory on the first display area detected by the touch sensor and second input trajectory information including information of the input trajectory on the second display area detected by the touch sensor, and determining a number of operators or identifying the operator, based on the first input trajectory information and the second input trajectory information stored in the memory.

Another aspect of the present invention is a control method controlling an in-vehicle information terminal apparatus, the in-vehicle information terminal apparatus including a touch panel input portion having a touch sensor configured to detect an input trajectory of a flick operation performed by an operator, a display unit, and an electronic control unit having a microprocessor and a memory connected to the microprocessor. The input trajectory is defined as a movement trajectory of a finger from a flick operation start point, where the operator touches a surface of the touch panel input portion, to a flick operation end point, where the operator releases the finger after moving the finger along the surface while maintaining contact. The control method includes controlling the display unit to display information in a first display area and a second display area arranged side by side in a left-right direction on the display unit, the first display area and the second display area being two information display areas each having a tile-like shape, storing, in the memory, first input trajectory information including information of the input trajectory on the first display area detected by the touch sensor and second input trajectory information including information of the input trajectory on the second display area detected by the touch sensor, and determining a number of operators or identifying the operator, based on the first input trajectory information and the second input trajectory information stored in the memory.

### BRIEF DESCRIPTION OF THE DRAWINGS

The objects, features, and advantages of the present invention will become clearer from the following description of embodiments in relation to the attached drawings, in which:

FIG. 1 is a view illustrating an example of mounting an in-vehicle information terminal apparatus according to an embodiment of the present invention on a vehicle;

FIG. 2 is a block diagram schematically illustrating a hardware configuration of the in-vehicle information terminal apparatus according to the embodiment of the present invention;

FIG. 3 is a view illustrating an example of an image displayed on a display of FIG. 1;

FIG. 4 is a view for describing a flick operation on the display of FIG. 1;

FIG. 5 is a flowchart illustrating an example of processing of a restaurant search application executed by a CPU of FIG. 2; and

FIG. 6 is a view illustrating an example of a route map displayed on the display of FIG. 1.

### DETAILED DESCRIPTION OF THE INVENTION

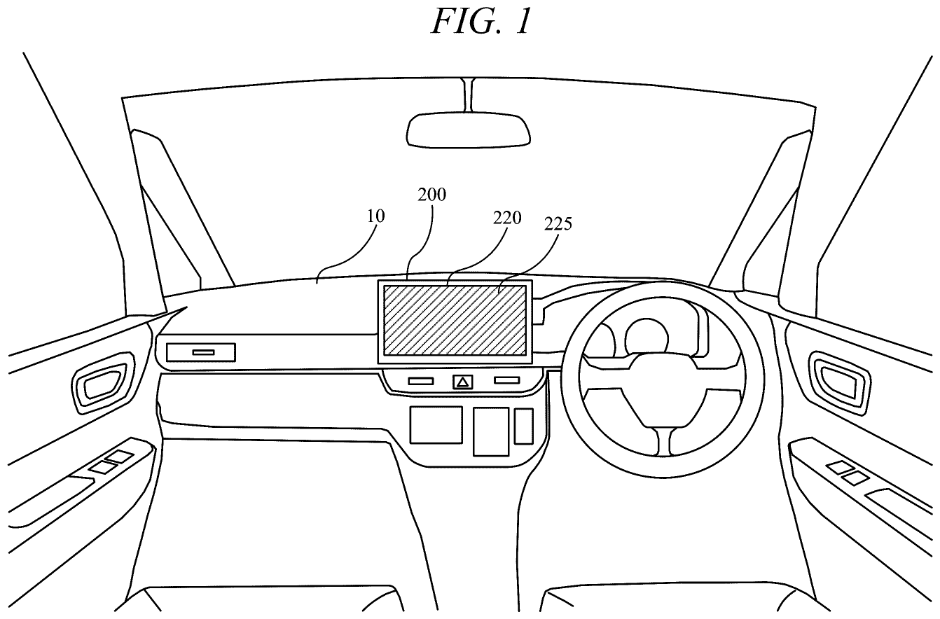

FIG. 1 is a view illustrating an example of mounting an in-vehicle information terminal apparatus according to an embodiment of the present invention on a vehicle. A display unit 200 is installed substantially near the center of an instrument panel 10 in a left-right direction, so an occupant (the driver) sitting on a driver's seat and an occupant sitting on a front passenger seat are able to reach by hand. In FIG. 1, an example is illustrated in which the driver's seat is located on the right in an advancing direction of the vehicle. The display unit 200 includes: a display 220; and a touch panel input portion (a touch sensor) 225, which is provided on the surface of the display 220, and which detects a touch operation by an operator.

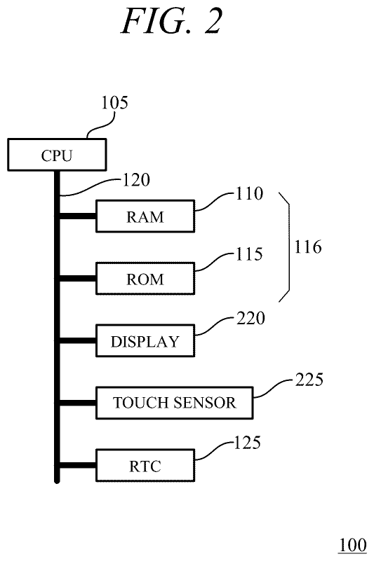

FIG. 2 is a block diagram schematically illustrating a hardware configuration of the in-vehicle information terminal apparatus 100. The in-vehicle information terminal apparatus 100 includes a CPU 105, a RAM 110, a ROM 115, a real-time clock (hereinafter, referred to as RTC) 125, the display 220, the touch panel input portion 225, and a system bus 120, which electrically connects these components to one another.

The ROM 115 includes an electrically rewritable ROM, and stores a program to be executed by the CPU 105, and the like. Various control programs read from the ROM 115 are stored in the RAM 110, as necessary, and the CPU 105 sequentially reads and executes the programs stored in the RAM 110. A VRAM area is ensured in the RAM 110, and display data in displaying information such as a graphical user interface, an image, and a character on the display 220 is transferred to the VRAM area, as necessary. The RAM 110 also functions as a work memory for temporarily storing information when the CPU 105 executes a program. Hereinafter, the RAM 110 and the ROM 115 will be collectively referred to as a storage unit 116.

The display 220 includes a flat panel display such as liquid crystal or organic EL, and is configured to be capable of displaying various types of graphical information, character information, and the like, as necessary.

The touch panel input portion 225 is provided on the surface of the display 220. The touch panel input portion 225 is configured to be capable of detecting an operator's touch operation. A flick operation is one of the operator's touch operations to be detectable by the touch panel input portion 225. In the present specification, the flick operation denotes an operation performed by an operator when the operator sequentially changes information such as images, characters, and symbols displayed on the display 220. When an operator's finger touches the surface of the touch panel input portion 225, the operator moves the finger in any direction along the surface of the touch panel input portion 225, that is, slides the finger while maintaining a touching state, and subsequently releases the finger from the surface of the touch panel input portion 225, the CPU 105 determines that the operator has performed the flick operation on the touch panel input portion 225, based on the operator's operation that has been detected by the touch panel input portion 225. The above-described flick operation will be referred to as a swipe operation, in some cases.

The RTC 125 is configured to be capable of detecting a time when a certain event occurs in the in-vehicle information terminal apparatus. For example, whenever the flick operation is detected, a start time or the like of the flick operation is configured to be detectable.

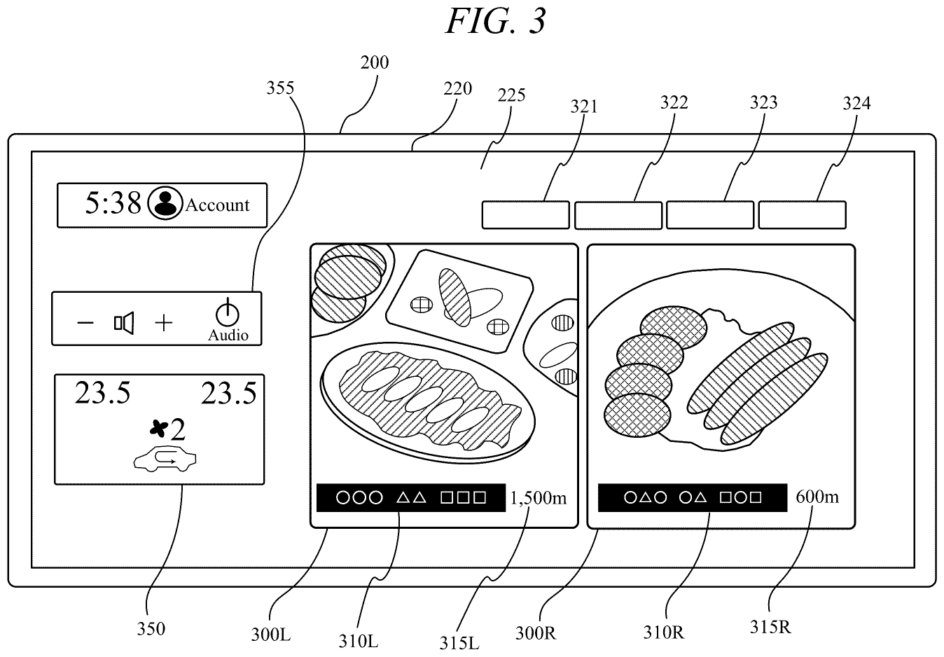

FIG. 3 is a view illustrating an example of an image displayed on the display 220. In the present embodiment, it is assumed that an operator activates an application program for searching for restaurants and corresponding displays are made. In addition to the application for searching for restaurants, fueling stations, charging stations, or the like may be searched for, or other facilities such as hospitals may be searched for.

Two display areas are set on the display 220 side by side laterally on the left and right, and information such as images and characters is displayed in these display areas. Of these two display areas, one located on the left will be referred to as a left tile 300L, and one located on the right will be referred to as a right tile 300R. In the present embodiment, as described with reference to FIG. 1, an example is illustrated in which the driver's seat is located on the right in the advancing direction of the own vehicle. Therefore, the left tile 300L can be regarded as a tile closer to the front passenger seat, and the right tile 300R can be regarded as a tile closer to the driver's seat. Contrary to the above description, in a case where the driver's seat is located on the left in the advancing direction of the own vehicle, the left tile 300L can be regarded as the tile closer to the driver's seat, and the right tile 300R can be regarded as the tile closer to the front passenger seat.

When the application for searching for restaurants is activated, information of a plurality of restaurants, for example, information of twenty stores located in the vicinity of the position of the own vehicle is acquired from a search engine operating in cooperation with the application, based on position information of the own vehicle detected by a GPS sensor or the like. The acquired information may include a store name, a genre of food and drink to be served, a price range, an image obtained by photographing the food and drink to be served, an image obtained by photographing the atmosphere in the store, a distance from the own vehicle to the store, and the like. The acquired information can be distributed and displayed on the left tile 300L and the right tile 300R by every ten stores, for example. FIG. 3 illustrates an example in which store information 310L and 310R such as the name of the store and the genre of the food and drink to be served, and distance information 315L and 315R indicating the distance from the own vehicle to the store are displayed in the left tile 300L and the right tile 300R together with the images of the food and drink to be served.

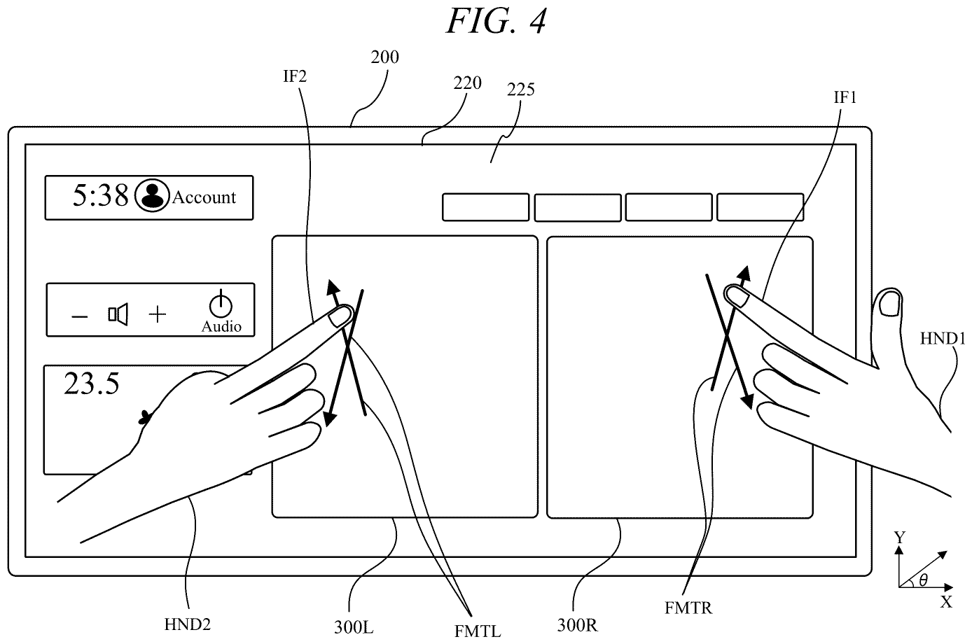

When the operator repeats the flick operation in the display area of the left tile 300L and the right tile 300R, images related to other stores are sequentially switched and displayed in response to the operation. In the present embodiment, information for the first to tenth stores, which are ten stores in total, is sequentially switched and displayed in the display area of each of the left tile 300L and the right tile 300R in response to the flick operation. Furthermore, when the flick operation is performed while the information of the tenth store is displayed, the information of the first store is displayed again. That is, so-called circulating display is made. Details of the flick operation will be described later with reference to FIG. 4.

Operation buttons 321, 322, 323, and 324 are displayed above the left tile 300L and the right tile 300R. By performing a touch operation on any of the operation buttons, the operator is able to set a search condition, and it is possible to display information of stores that satisfy the search condition on the left tile 300L and the right tile 300R. For example, the genre of food and drink, a degree of popularity, the price range, and the distance from the own vehicle are set as the search conditions. This enables extraction and display of necessary information in an urban area where there are lots of restaurants.

In addition to the display described above, it is also possible to display an audio graphical user interface (GUI) 355, which receives an audio-related operation, an air conditioner GUI 350, which receives an operation for the air conditioner in the vehicle, and the like, as necessary.

FIG. 4 is a view for describing the flick operation on the display 220. More specifically, the view illustrates examples of the flick operation by the operator for switching the information displayed on the left tile 300L and the right tile 300R, which are provided side by side laterally on the left and right, to the next information.

In FIG. 4, a first hand HND1 is an occupant's hand on the driver's seat, and a second hand HND2 is an occupant's hand on the front passenger seat. An element schematically drawn by a straight line with an arrowhead at one end in the right tile 300R denotes a right flick input trajectory FMTR. When the operator performs the flick operation with the first hand HND1 on an area corresponding to the right tile 300R of the touch panel input portion 225, a first index finger IF1, which is the index finger of the first hand HND1, touches the surface of the touch panel input portion 225 at an end point with no arrowhead in the right flick input trajectory FMTR as illustrated in FIG. 4. Such an end point will be referred to as a flick start point. After sliding on the touch panel input portion 225, the first index finger IF1 is separated from the surface of the touch panel input portion 225 at a tip end with an arrowhead in the right flick input trajectory FMTR. Such a tip end with the arrowhead will be referred to as a flick end point. The above-described flick operation is not necessarily performed with the index finger. Depending on the operator's habit, the flick operation may be performed with another finger.

Similarly, an element schematically drawn by a straight line with an arrowhead at one end in the left tile 300L denotes a left flick input trajectory FMTL. A second index finger IF2, which is the index finger of the second hand HND2, touches the surface of the touch panel input portion 225 at an end point with no arrowhead in the left flick input trajectory FMTL, that is, the flick start point. After sliding on the touch panel input portion 225, the second index finger IF2 is separated from the surface of the touch panel input portion 225 at a tip end with an arrowhead in the left flick input trajectory FMTL, that is, the flick end point. The above-described flick operation performed on the touch panel input portion on an area corresponding to the left tile 300L is not necessarily performed with the index finger. Depending on the operator's habit, the flick operation may be performed with another finger.

As described above, the input trajectory of the flick operation that has been detected by the touch panel input portion 225 on the area corresponding to the right tile 300R will be referred to as the right flick input trajectory FMTR, and the input trajectory of the flick operation that has been detected by the touch panel input portion 225 on the area corresponding to the left tile 300L will be referred to as the left flick input trajectory FMTL. Whenever the touch panel input portion 225 detects an operator's flick operation, the CPU 105 (FIG. 2) stores information about the flick operation input trajectory in the storage unit 116.

For the information about the flick operation input trajectory, for example, X axis and Y axis are defined in the direction along the long side and the short side of the touch panel input portion 225, the intersection of X axis and Y axis is set as the origin, and the flick start point and the flick end point can be expressed by X and Y coordinate values. It is also possible to express the information with a combination of the coordinate values of the flick start point, information of an azimuth angle from the flick start point to the flick end point, and a distance from the flick start point to the flick end point. It is also possible to use information of only the distance from the flick start point to the flick end point. When the fingertip moves on the touch panel input portion 225 in accordance with the flick operation, the touch coordinate position that changes with the lapse of time can be sequentially detected, and such a detection result can be used as the information of the trajectory. The time when the touch panel input portion 225 detects the flick operation is obtained from the RTC 125, and it is possible to set the information about the flick operation input trajectory also including the information about the time. For example, whenever the flick operation is detected in both the left tile 300L and the right tile 300R, the flick operation start timing can be sequentially stored.

The CPU 105 determines whether one operator performs the flick operation or two operators perform the flick operations on the touch panel input portion 225 and whether the occupant in the driver's seat or the occupant in the front passenger seat performs the flick operation, based on the information about the flick input trajectory. This point will be described in detail below.

In FIG. 4, in a situation in which the driver's seat is located on the right in the vehicle advancing direction of the own vehicle, the driver sitting on the driver's seat operates the steering wheel with the right hand, and performs the flick operation with the left hand. The driver performs the flick operation while paying attention to the situation of the own vehicle obtained from a forward side of the vehicle and via the door mirror or the rearview mirror. Thus, it is assumed that an operation mode is similar to a blind touch. In this case, if the left hand hangs in the air, the operation will be unstable. For this reason, as illustrated in FIG. 4, the driver makes the thumb of the left hand (the first hand HND1) touch the display unit 200 to stabilize the left hand, and performs the flick operation using the first index finger IF1 or the like. In this case, the right flick input trajectory FMTR tends to move toward the upper right or the lower right as illustrated in FIG. 4. In addition, when the driver stretches the left hand and performs the flick operation in the area corresponding to the left tile 300L, the flick input trajectory tends to be similar to the above-described one.

On the other hand, in FIG. 4, the occupant on the front passenger seat performs the flick operation with the right hand. In this case, the left flick input trajectory FMTL tends to move toward the upper left or the lower left as illustrated in FIG. 4. In particular, when both of the occupants on the driver's seat and the front passenger seat perform the flick operations at the same time or perform the flick operations at similar timings to the same time (when a difference in time when the flick operations are performed falls within a predetermined time), they perform the operations so that the fingers do not interfere with each other. This is the reason why the left and right flick input trajectories exhibit the above-described tendencies.

When the occupant on the front passenger seat performs the flick operation in the area corresponding to the right tile 300R while stretching the right hand, the flick input trajectory tends to be similar to the above-described one.

In a case where the driver's seat is located on the left contrary to the above description, it is highly probable that the driver performs the flick operation with the right hand while the occupant on the front passenger seat performs the flick operation with the left hand. For this reason, it is possible to determine that the left flick input trajectory FMTL is made by the driver's flick operation, and the right flick input trajectory FMTR is made by the flick operation by the occupant on the front passenger seat.

The CPU 105 is configured to determine whether the occupant who has performed the flick operation is the driver on the driver's seat or the occupant on the front passenger seat, based on the above-described tendencies of the flick operations. In a case where the driver's seat is located on the right in the advancing direction of the own vehicle, upon detection of a flick input trajectory indicated as the right flick input trajectory FMTR illustrated in FIG. 4, the CPU 105 determines that the flick operation has been performed by the driver. On the other hand, upon detection that the flick input trajectory indicated as the left flick input trajectory FMTL, the CPU 105 determines that the flick operation has been performed by the occupant on the front passenger seat.

In the case where the driver's seat is located on the right in the advancing direction of the own vehicle, the right flick input trajectory FMTR is directed obliquely upward to the right or obliquely downward to the right along the surface of the touch panel input portion 225 on the right (the driver's seat) in the right tile 300R, in some cases. In consideration of this, when the start point of the flick operation is located on the right in the right tile 300R (the tile closer to the driver's seat), the CPU 105 determines that the operator of the flick operation is the driver.

In addition, in the case where the driver's seat is located on the right in the advancing direction of the own vehicle, the left flick input trajectory FMTL is directed obliquely upward to the left or obliquely downward to the left along the surface of the touch panel input portion 225 on the left in the left tile 300L (closer to the front passenger seat). In consideration of this, when the start point of the flick operation is located on the left in the left tile 300L (the tile closer to the front passenger seat), the CPU 105 determines that the operator of the flick operation is the occupant on the front passenger seat.

In a case where the driver's seat is located on the left in the advancing direction of the own vehicle contrary to the above description, when the left flick input trajectory FMTL is directed obliquely upward to the left or obliquely downward to the left along the surface of the touch panel input portion 225, and the start point of the flick operation is located on the left in the left tile 300L (the tile closer to the driver's seat), the CPU 105 determines that the operator of the flick operation is the driver. In the case where the driver's seat is located on the left in the advancing direction of the own vehicle, when the right flick input trajectory FMTR is directed obliquely upward to the right or obliquely downward to the right along the surface of the touch panel input portion 225, and the start point of the flick operation is located on the right in the right tile 300R (the tile closer to the front passenger seat), the CPU 105 determines that the operator of the flick operation is the occupant on the front passenger seat.

Subsequently, an example of determining whether one operator operates or a plurality of operators operate the in-vehicle information terminal apparatus will be described. The CPU 105 sequentially stores information about the flick input trajectory in the storage unit 116 whenever the flick operation is detected by the touch panel input portion 225. Then, statistical processing is performed on each of the stored pieces of left flick input trajectory information about a plurality of left flick input trajectories FMTL and the stored pieces of right flick input trajectory information about a plurality of right flick input trajectories FMTR. For example, an average value is calculated as the statistical processing.

The CPU 105 compares the processed flick input trajectory information, and obtains a degree of coincidence between the flick input trajectories. Then, in a case where the degree of coincidence is equal to or higher than a predetermined degree, the CPU 105 determines that one operator operates the in-vehicle information terminal apparatus (touch pane input portion 225). In a case where the degree of coincidence is lower than the predetermined degree, the CPU 105 determines that a plurality of operators operate the in-vehicle information terminal apparatus (touch panel input portion 225).

From each of the plurality of pieces of left flick input trajectory information and the plurality of pieces of right flick input trajectory information that are stored in the storage unit 116, the CPU 105 is capable of obtaining information about an azimuth angle with reference to a coordinate axis extending in the long side direction or the short side direction of the display 220 along the surface of the display 220, that is, information about an azimuth angle in which the flick input trajectory is directed along the touch panel input portion 225. As an example of this case, X and Y coordinate axes and an azimuth angle θ are illustrated in a lower right part of FIG. 4. The azimuth angle θ is defined to increase in value in a clockwise direction with reference to X axis.

The CPU 105 obtains an average value for each azimuth angle of the plurality of detected and stored left and right flick input trajectories. Then, in a case where an azimuth angle average value of the left flick input trajectory and an azimuth angle average value of the right flick trajectory are different from each other by a predetermined angle or more (for example, five degrees or more, preferably 30 degrees or more), it is determined that the degree of coincidence is lower than a predetermined degree.

As another example, the CPU 105 calculates a distance between the flick start point and the flick end point detected for every flick operation from each of the plurality of pieces of left flick input trajectory information and the plurality of pieces of right flick input trajectory information that are stored in the storage unit 116. Furthermore, the CPU 105 calculates an average value for each of the above distance values respectively stored as the right flick input trajectory information and the left flick input trajectory information. Then, in a case where the difference between the average values is equal to or larger than a predetermined value (for example, one millimeter or more, preferably five millimeters or more), the CPU 105 determines that the degree of coincidence is lower than the predetermined degree.

As still another example, each of the plurality of pieces of left flick input trajectory information and right flick input trajectory information that are stored in the storage unit 116 includes time information obtained from the RTC 125 when start of the flick operation is detected, that is, information of a left flick operation start timing and information of a right flick operation start timing. In this case, the CPU 105 is capable of determining whether there is one operator or there are two operators by referring to these pieces of information. As an example, in a case where a time difference between the left flick operation start timing and the right flick operation start timing detected continuously to the left flick operation is shorter than a predetermined time (for example, 0.5 seconds), the CPU 105 determines that there are two operators. This is because it is difficult for one operator to perform the flick operation in both areas corresponding to the left tile 300L and corresponding to the right tile 300R in a short time.

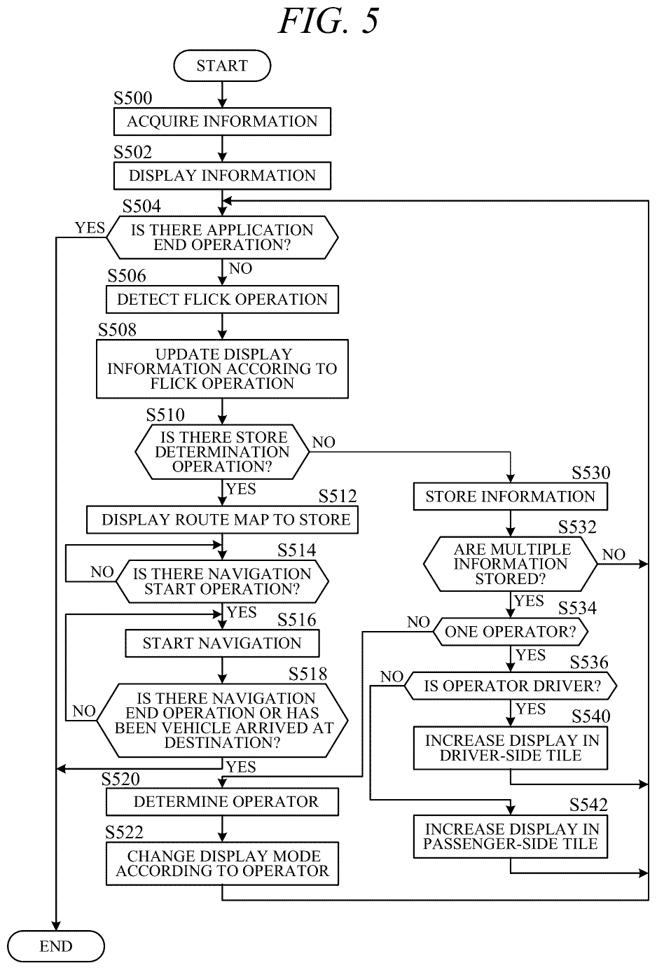

FIG. 5 is a flowchart illustrating an example of processing of the restaurant search application executed by the CPU 105 of FIG. 2 in accordance with a program stored beforehand. When the restaurant search application starts to be executed, as illustrated in FIG. 5, the CPU 105 acquires store information near the own vehicle from the search engine, based on own vehicle position information detected by a position detection unit such as a GPS sensor mounted on the vehicle in S500 (S: processing step). For example, the CPU 105 outputs the own vehicle position information, information identifying a genre desired to be searched for, information specifying a necessary answer, and the like to the search engine operating in cooperation with the restaurant search application. The store information includes the position of a store, opening and closing times, business days, images of dishes or beverages to be served, images obtained by photographing the atmosphere in the store, the price range, the genre of dishes to be served, recommended dishes, evaluation information from customers, and the like. In a case where there is little available information because the own vehicle is located in a depopulated region, the CPU 105 is also capable of outputting an instruction to enlarge the searched region to the search engine. Conversely, in a case where the own vehicle is located in a downtown and there is too much available information, the CPU 105 is capable of narrowing down the store information output from the search engine to, for example, about twenty stores.

Next, in S502, the CPU 105 outputs a control signal to the display 220, and distributes, for example, every 10 candidates in the information display areas of the left tile 300L and the right tile 300R to display the information. When the operator performs the flick operation in the display area of the left tile 300L or the right tile 300R, the operator is able to browse the information while sequentially switching the information for ten stores as if turning cards of a card game.

Next, in S504, the CPU 105 determines whether there is an operation by the operator to end the application. The detection of an application end operation includes, for example, detecting an operation of pressing an “end” button (not illustrated) displayed in the display 220. It may be detected by voice recognition that an instruction to end the application has been given. In a case where an affirmative determination is made in S504, the restaurant search application ends.

In a case where a negative determination is made in S504, the CPU 105 performs flick operation detection processing in S506. In this case, when a touch sensor of the touch panel input portion 225 detects the flick operation by the operator in the information display area of the left tile 300L and the right tile 300R, the CPU 105 acquires information of the flick input trajectory. On the other hand, in a case where an affirmative determination is made in S504, the CPU 105 ends the processing of FIG. 5.

When the flick operation is detected in S506, the CPU 105 updates the information in the information display area in which the flick operation that has been detected in response to the detected flick operation in S508 (switches the display to the next information). Next, in S510, the CPU 105 determines whether the operator has performed an operation of determining the store. An example of the operation of determining the store is a predetermined long press operation performed by the operator in the area in which information such as the image is displayed in the information display area of either the left tile 300L or the right tile 300R, that is, an operation of maintaining a state of pressing the touch panel input portion with a finger for a predetermined time or more, for example, one second or more.

In a case where a negative determination is made in S510, the CPU 105 stores the information about the flick input trajectory acquired in S506 in the storage unit 116 in S530. Next, in S532, the CPU 105 determines whether a plurality of pieces of information about the flick input trajectory are stored in the storage unit 116. In a case where a negative determination is made in S532, the processing returns to S504.

In a case where an affirmative determination is made in S532, the processing proceeds to S534, and the CPU 105 determines whether there is one operator who operates the touch panel input portion 225, based on the input trajectory information of the flick operation stored in S530 as described above. In a case where an affirmative determination is made in S534, the processing proceeds to S536, and the CPU 105 determines whether the operator is the driver, based on the input trajectory information of the flick operation as described above.

In a case where an affirmative determination is made in S536, the processing proceeds to S540, and the CPU 105 outputs a control signal to the display 220 to increase the number of pieces of store information distributed to the information display area in the tile closer to the driver's seat, for example, the right tile 300R, in the case where the driver's seat is located on the right as illustrated in FIG. 2. In the description of the processing in S502, as an example, the description has been made with regard to a case where the information of every ten stores is distributed to each of the information display areas in the left tile 300L and the right tile 300R. However, for example, it is possible to display information of five stores in the information display area of the left tile 300L and information of fifteen stores in the information display area of the right tile 300R. Alternatively, all the information of twenty stores may be displayed in the information display area in the right tile 300R, which is the tile closer to the driver's seat. After the processing of S540, the processing returns to S504.

On the other hand, in a case where a negative determination is made in S536, that is, in a case where it is determined that the operator is the occupant on the front passenger seat, the processing proceeds to S542. The CPU 105 outputs a control signal to the display 220, and increases the number of pieces of store information distributed to the information display area of the tile closer to the front passenger seat, and then the processing returns to S504.

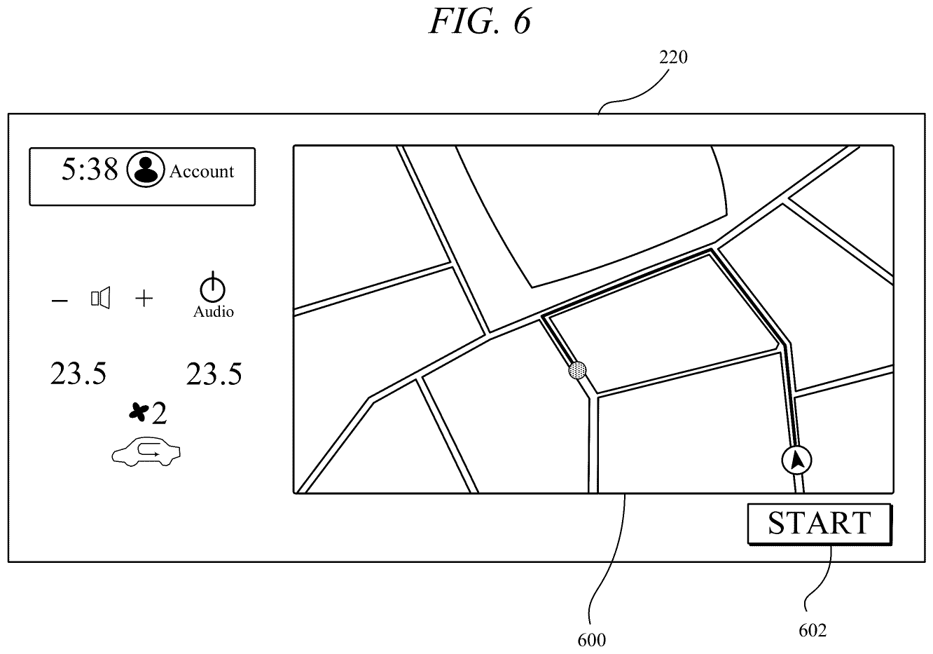

In a case where an affirmative determination is made in S510, the processing proceeds to S512, and the CPU 105 controls the display 220 to display a route map indicating a route to the determined store (a destination). FIG. 6 is a view illustrating an example of a route map 600, which is displayed on the display 220.

Next, in S514, the CPU 105 determines whether there is an operation for instructing to start navigation. For example, it is determined whether a navigation start button 602 of FIG. 6 is pressed by the operator. S514 is repeated until an affirmative determination is made. During this time, when an operation to interrupt the navigation operation or to end the restaurant search application is detected, the processing of S514 may end.

In a case where an affirmative determination is made in S514, the CPU 105 starts the navigation to the destination in S516. Next, in S518, the CPU 105 determines whether there is an operation to end the navigation and whether the own vehicle has arrived at the destination. In a case where a negative determination is made in S518, the processing returns to S516. In a case where an affirmative determination is made, the CPU 105 ends the processing illustrated in FIG. 5.

In a case where a negative determination is made in S534, that is, in a case where it is determined that there are a plurality of operators who operate the in-vehicle information terminal apparatus 100, for example, two operators including the driver on the driver's seat and the occupant on the front passenger seat, the processing proceeds to S520. In S520, the CPU 105 determines which one of the operation by the driver or the operation by the occupant on the front passenger seat corresponds to the operation performed by plurality of operators, based on the input trajectory information of the flick operation stored in S530.

Next, in S522, the CPU 105 changes the display mode of the information to be displayed on the left and right tiles 300L and 300R, based on a determination result in S520. For example, in a case where it is determined that the operation is performed by the occupant on the front passenger seat, more detailed information is displayed on the tile 300L, which is closer to the front passenger seat, and simpler information is displayed on the tile 300R, which is closer to the driver's seat. On the other hand, in a case where it is determined that the operation is performed by the occupant on the driver's seat, the amount of information to be displayed on the tile 300R, which is closer to the driver's seat, is larger than that in the case where it is determined that the operation is performed by the occupant on the front passenger seat. In this manner, in a case where it is determined that there is one operator, the CPU 105 displays the image in a first mode on the display 220 (S540, S542). In a case where it is determined that there are a plurality of operators, the CPU 105 displays the image in a second mode on the display 220 (S522).

According to the present embodiment, the following operations and effects are achievable.

(1) The in-vehicle information terminal apparatus 100 includes: the touch panel input portion (i.e., touch sensor) 225, which is capable of detecting the input trajectories FMTL and FMTR of the flick operations by the operators; the display 220; the storage unit 116 (the RAM 110 and the like); and a controller (the CPU 105) (FIGS. 2 to 4). The input trajectories FMTL and FMTR of the flick operation are the movement trajectories of a finger from when the operator of the in-vehicle information terminal apparatus 100 touches the flick operation start point on the surface of the touch panel input portion 225 with the finger, and moves the finger along the surface while keeping the touch, to when the operator releases the finger at the flick operation end point. The CPU 105 displays information in the right tile 300R (referred to as a first display area) and the left tile 300L (referred to as a second display area), which are two information display areas each having a tile shape, and which are set side by side in the left-right direction on the display 220; stores, in the storage unit 116, the first input trajectory information including information of the input trajectory FMTR (FIG. 4) of the flick operation, detected by the touch panel input portion 225, on the first display area 300R, and the second input trajectory information including information of the input trajectory FMTL (FIG. 3) of the flick operation, detected by the touch panel input portion 225, on the second display area 300L; compares a plurality of pieces of the first input trajectory information that have been stored with a plurality of pieces of the second input trajectory information that have been stored to obtain a degree of coincidence between trajectories; determines that there is one operator who operates the in-vehicle information terminal apparatus in a case where the degree of coincidence is equal to or higher than a predetermined degree; and determines that there are a plurality of operators who operate the in-vehicle information terminal apparatus 100 in a case where the degree of coincidence is lower than the predetermined degree (FIG. 5).

This eliminates the use of a sensor for operator detection, enables the determination of whether there is one operator who has performed the flick operation or there are a plurality of operators who have performed the flick operations on the in-vehicle information terminal apparatus 100, and enables the configuration at low cost.

(2) The degree of coincidence in the trajectories denotes a degree of coincidence between the average value in the first flick operation direction, which is the direction from the touch position of the operator's finger toward the position where the operator's finger is separated, and which has been detected a plurality of times by the touch panel input portion 225 on the first display area 300R, and the average value in the second flick operation direction, which is the direction from the touch position of the operator's finger toward the position where the operator's finger is separated, and which has been detected a plurality of times by the touch panel input portion 225 on the second display area 300L. In this manner, by determining whether there is one operator who has performed the flick operation or there are a plurality of operators who have performed the flick operations on the in-vehicle information terminal apparatus 100 using the degree of coincidence between the respective average values in the first flick direction and the second flick direction, it becomes possible to eliminate the influence of the variation in the operation of every flick operation and to determine the number of operators more accurately.

(3) The degree of coincidence of the trajectories can be a degree of coincidence between the average value of the first flick lengths, which are lengths of the trajectories from the touch position of the operator's finger to the position where the operator's finger is separated, and which have been detected a plurality of times by the touch panel input portion 225 on the first display area 300R, and the average value of the second flick lengths, which are lengths of the trajectories from the touch position of the operator's finger to the position where the operator's finger is separated, and which have been detected a plurality of times by the touch panel input portion on the second display area 300L. In this manner, by determining whether there is one operator who has performed the flick operation or there are a plurality of operators who have performed the flick operations on the in-vehicle information terminal apparatus 100 using the degree of coincidence of the average values of the first flick lengths and the second flick lengths, it becomes possible to eliminate the influence of the variation in the operation of every flick operation and to determine the number of operators more accurately in relatively simple processing.

(4) The CPU 105 is also capable of storing, in the storage unit 116, the first operation start timing, which is the start timing of the flick operation that has been detected in the first display area 300R, and the second operation start timing, which is the start timing of the flick operation that has been detected in the second display area 300L, and determining that there are a plurality of operators in a case where a time difference between the first operation start timing and the second operation start timing that has been detected continuously to the first operation start timing is shorter than a predetermined time. In this manner, by comparing the first operation start timing and the second operation start timing, it becomes possible to determine the number of operators more certainly.

(5) In a case where the first input trajectory information stored in the storage unit 116 includes a predetermined flick operation in a direction from the front passenger seat (passenger-side) toward the driver's seat (driver side), the CPU 105 determines that the predetermined flick operation is performed by the driver.

This eliminates the use of the sensor for operator detection, and enables the determination of whether the operator is the driver.

(6) The predetermined flick operation can include an operation directed toward the driver's seat (driver-side) and obliquely upward and an operation directed toward the driver's seat (driver-side) and obliquely downward. This enables the determination of whether the operator is the driver more certainly.

(7) In a case where the flick operation start point is located closer to the driver's seat in the first display area, it is possible to determine that the operator is the driver. This enables the determination of whether the operator is the driver more certainly.

(8) The control method controls the in-vehicle information terminal apparatus 100 (FIG. 2) including the touch panel input portion 225, which is capable of detecting the input trajectories FMTL and FMTR of the flick operations by the operators, the display 220, the storage unit 116 (the RAM 110 and the like), and the CPU 105. The input trajectories FMTL and FMTR of the flick operations are the movement trajectories of a finger from when the operator of the in-vehicle information terminal apparatus touches the flick operation start point on the surface of the touch panel input portion 225 with the finger, and moves the finger along the surface while keeping the touch, to when the operator releases the finger at the flick operation end point. The control method includes:
displaying information in the first display area 300R and the second display area 300L, which are two information display areas each having a tile shape, and which are set side by side in the left-right direction on the display 220; storing, in the storage unit 116, the first input trajectory information including information of the input trajectory FMTR of the flick operation, detected by the touch panel input portion 225, on the first display area 300R, and the second input trajectory information including information of the input trajectory FMTL of the flick operation, detected by the touch panel input portion 225, on the second display area 300L; comparing a plurality of pieces of the first input trajectory information that have been stored with a plurality of pieces of the second input trajectory information that have been stored to obtain a degree of coincidence between trajectories, determining that there is one operator who operates the in-vehicle information terminal apparatus in a case where the degree of coincidence is equal to or higher than a predetermined degree; and determining that there are a plurality of operators who operate the in-vehicle information terminal apparatus 100 in a case where the degree of coincidence is lower than the predetermined degree.

This eliminates the use of a sensor for operator detection, enables the determination of whether there is one operator who has performed the flick operation or there are a plurality of operators who have performed the flick operations on the in-vehicle information terminal apparatus 100.

(9) In a case where the first input trajectory information that has been stored includes a predetermined flick operation in a direction from the front passenger seat (passenger-side) toward the driver's seat (driver-side), the control method is also capable of determining that the predetermined flick operation is an operation performed by the driver.

This eliminates the use of the sensor for operator detection, and enables the determination of whether the operator is the driver.

In the above embodiment, an example of a display of display 220 when the driver's seat is positioned on the right side of the vehicle. However, display 220 can similarly be configured when the driver's seat is positioned on the left side of the vehicle. That is, a first display area on a driver-side may be positioned on the left side of display 220 instead of the right side, and a second display area on a passenger-side may be positioned on the right side of the display 220 instead of the left side. In the above embodiment, information (first input information) regarding the input trajectory FMT of the flick operation on the display area of the right tile 300R is stored in the storage unit 116. However, other information may also be included in the first input information stored in the storage unit 116. Furthermore, in the above embodiment, information (second input information) regarding the input trajectory FMT of the flick operation on the display area of the left tile 300L is stored in the storage unit 116. However, other information may also be included in the second input information stored in the storage unit 116.

In the above embodiment, the touch panel input portion 225 detects the flick operation (a first flick operation) on the display area of the right tile 300R and the flick operation (a second flick operation) on the display area of the left tile 300L. Specifically, the first flick operation direction is defined as the direction from the operator's finger touch position on the display area of the right tile 300R toward the position where the operator's finger leaves the touch position, and the second flick operation direction is defined as the direction from the operator's finger touch position on the display area of the left tile 300L toward the position where the operator's finger leaves the touch position. However, when the left-right positions of the driver's seat and passenger seat are reversed, the left and right directions described above may be reversed accordingly.

In the above embodiment, the flick operation directed rightward and downward and the flick operation directed rightward and upward on the display area of the right tile 300R were defined as a predetermined flick operation moving from the passenger-side toward the driver-side, and this predetermined flick operation was determined to be an operation by the driver. However, the predetermined flick operation moving from the passenger-side toward the driver-side is not limited to the above. For example, a substantially horizontal flick operation toward the right may also be included as a predetermined flick operation. When the left-right relationship between the driver's seat and passenger seat is reversed, the left and right described above are reversed.

The above embodiment can be combined as desired with one or more of the above modifications. The modifications can also be combined with one another.

According to the present invention, it is possible to determine the number of operators or identify the operator of an in-vehicle information terminal apparatus without using dedicated sensors that cause cost increases.

Above, while the present invention has been described with reference to the preferred embodiments thereof, it will be understood, by those skilled in the art, that various changes and modifications may be made thereto without departing from the scope of the appended claims.

What is claimed is:

1. An in-vehicle information terminal apparatus comprising:
a touch panel input portion including a touch sensor configured to detect an input trajectory of a flick operation performed by an operator;
a display unit; and
an electronic control unit having a microprocessor and a memory connected to the microprocessor, wherein
the input trajectory is defined as a movement trajectory of a finger from a flick operation start point, where the operator touches a surface of the touch panel input portion, to a flick operation end point, where the operator releases the finger after moving the finger along the surface while maintaining contact, and
the microprocessor is configured to perform
controlling the display unit to display information in a first display area and a second display area arranged side by side in a left-right direction on the display unit, the first display area and the second display area being two information display areas each having a tile-like shape,
storing, in the memory, first input trajectory information including information of the input trajectory on the first display area detected by the touch sensor and second input trajectory information including information of the input trajectory on the second display area detected by the touch sensor, and
determining a number of operators or identifying the operator, based on the first input trajectory information and the second input trajectory information stored in the memory.

2. The in-vehicle information terminal apparatus according to claim 1, wherein
the microprocessor is configured to further perform
comparing a plurality of the first input trajectory information stored in the memory with a plurality of the second input trajectory information stored in the memory to determine a degree of coincidence between movement trajectories, and
the determining including determining that the number of operators is one when the degree of coincidence is equal to or greater than a predetermined degree, and the number of operators is plural when the degree of coincidence is less than the predetermined degree.

3. The in-vehicle information terminal apparatus according to claim 2, wherein
a direction of the movement trajectory from the flick operation start point toward the flick operation end point detected by the touch sensor on the first display area is a first flick operation direction,
a direction of the movement trajectory from the flick operation start point toward the flick operation end point detected by the touch sensor on the second display area is a second flick operation direction, and
the degree of coincidence of the movement trajectories is a degree of coincidence between an average value of a plurality of first flick operation directions and an average value of a plurality of second flick operation directions.

4. The in-vehicle information terminal apparatus according to claim 2, wherein
a length of the movement trajectory from the flick operation start point to the flick operation end point detected by the touch sensor on the first display area is a first flick length,
a length of the movement trajectory from the flick operation start point to the flick operation end point detected by the touch sensor on the second display area is a second flick length, and
the degree of coincidence of the movement trajectories is a degree of coincidence between an average value of a plurality of first flick lengths and an average value of a plurality of second flick lengths.

5. The in-vehicle information terminal apparatus according to claim 2, wherein
the microprocessor is configured to further perform
storing, in the memory, a first operation start timing defined as a start timing of the flick operation detected on the first display area, and a second operation start timing defined as a start timing of the flick operation detected on the second display area, and
the determining including determining that the number of operators is plural when the flick operation on the first display area and the flick operation on the second display area are continuously detected and when a time difference between the first operation start timing and the second operation start timing is shorter than a predetermined time.

6. The in-vehicle information terminal apparatus according to claim 1, wherein
the microprocessor is configured to perform
the identifying including identifying that the operator of the flick operation is a driver when the first input trajectory information stored in the memory includes a predetermined flick operation directed from a passenger-side toward a driver-side on the surface of the touch panel input portion.

7. The in-vehicle information terminal apparatus according to claim 6, wherein
the predetermined flick operation includes an operation directed obliquely upward toward the driver-side and an operation directed obliquely downward toward the driver-side.

8. The in-vehicle information terminal apparatus according to claim 6, wherein
the microprocessor is configured to perform
the identifying including further identifying that the operator of the flick operation is the driver when the flick operation start point is located on the driver-side within the first display area.

9. The in-vehicle information terminal apparatus according to claim 2, wherein
the microprocessor is configured to perform
the controlling including controlling the display unit to display the information in a first mode when it is determined that the number of operators is one, and to display the information in a second mode different from the first mode when it is determined that the number of operators is plural.

10. The in-vehicle information terminal apparatus according to claim 6, wherein
the microprocessor is configured to perform
the controlling including controlling the display unit such that an amount of the information displayed is reduced when it is determined that the predetermined flick operation is performed by the driver, as compared with when it is determined that the predetermined flick operation is not performed by the driver.

11. The in-vehicle information terminal apparatus according to claim 6, wherein
the microprocessor is configured to perform
the controlling including controlling the display unit such that, when the predetermined flick operation is determined to be performed by the driver, a first predetermined number of images are switchably displayed in accordance with the flick operation in the first display area and a second predetermined number of images smaller than the first predetermined number are switchably displayed in accordance with the flick operation in the second display area.

12. A control method controlling an in-vehicle information terminal apparatus, the in-vehicle information terminal apparatus including a touch panel input portion having a touch sensor configured to detect an input trajectory of a flick operation performed by an operator, a display unit, and an electronic control unit having a microprocessor and a memory connected to the microprocessor, wherein
the input trajectory is defined as a movement trajectory of a finger from a flick operation start point, where the operator touches a surface of the touch panel input portion, to a flick operation end point, where the operator releases the finger after moving the finger along the surface while maintaining contact, and
the control method comprises
controlling the display unit to display information in a first display area and a second display area arranged side by side in a left-right direction on the display unit, the first display area and the second display area being two information display areas each having a tile-like shape,
storing, in the memory, first input trajectory information including information of the input trajectory on the first display area detected by the touch sensor and second input trajectory information including information of the input trajectory on the second display area detected by the touch sensor, and
determining a number of operators or identifying the operator, based on the first input trajectory information and the second input trajectory information stored in the memory.

13. The control method according to claim 12, further comprising
comparing a plurality of the first input trajectory information stored in the memory with a plurality of the second input trajectory information stored in the memory to determine a degree of coincidence between movement trajectories, wherein
the determining includes determining that the number of operators is one when the degree of coincidence is equal to or greater than a predetermined degree, and the number of operators is plural when the degree of coincidence is less than the predetermined degree.

14. The control method according to claim 12, wherein
the identifying includes identifying that the operator of the flick operation is a driver when the first input trajectory information stored in the memory includes a predetermined flick operation directed a passenger-side toward a driver-side on the surface of the touch panel input portion.
